(19) United States
(12) Patent Application Publication
(10) Pub. No.: US 2024/0178716 A1
(43) Pub. Date: May 30, 2024

(54) Pressure Equalization Arrangement and Electric Machine

(71) Applicant: Bayerische Motoren Werke Aktiengesellschaft, Muenchen (DE)

(72) Inventors: Maximilian ROSENBERGER, Muenchen (DE); Thomas SPIESS, Muenchen (DE)

(21) Appl. No.: 18/283,140

(22) PCT Filed: Apr. 12, 2022
(86) PCT No.: PCT/EP2022/059752

§ 371 Date: Sep. 20, 2023

(30) Foreign Application Priority Data
May 7, 2021 (DE) 10 2021 111 907.3

(51) Int. Cl. H02K 5/10; H02K 5/14

(52) U.S. Cl. CPC H02K 5/10; H02K 5/14; H02K 2205/09

(57) ABSTRACT

A pressure equalisation arrangement for a compartment of an electric machine of a motor vehicle, in which a vent pipe, via which gas can flow out of the compartment for pressure equalisation, is connected to the compartment to be vented. A free end of the vent pipe protrudes from below into an upwardly closed recess which is provided by a component and in which a gas bubble collects as a water level rises, the free end of the vent pipe having a vent opening protruding into the gas bubble.

### BACKGROUND AND SUMMARY OF THE INVENTION

The invention relates to a pressure equalization arrangement for a chamber of an electric machine of a motor vehicle and an electric machine for a motor vehicle.

German patent document DE 10 2017 223 491 A1 discloses an electric machine arrangement comprising two electric machines each having a housing. Each housing has a machine chamber having a rotor/stator arrangement and a resolver chamber portion which forms a portion of a resolver chamber which is formed between the machine chambers and which is sealed in the direction toward the machine chambers. In the electric machine arrangement, a plurality of pressure equalization elements which are associated with the machine chambers and the resolver chamber are provided. The pressure equalization elements, via which the machine chambers can be vented, are arranged above a wading line when viewed in the vertical direction of the electric machine arrangement.

An object of the present invention is to provide a solution which allows a particularly reliable venting of a chamber of an electric machine with a particularly small risk of penetration of water into the chamber of the electric machine.

This object is achieved according to the invention by the subject-matter of the independent patent claim. Additional possible configurations of the invention are disclosed in the dependent claims, the description and the Figures.

The invention relates to a pressure equalization arrangement for a chamber of an electric machine of a motor vehicle. By means of this electric machine, the motor vehicle can be driven with electrical energy. In the pressure equalization arrangement there is provision for a venting pipe, via which gas can flow out of the chamber for pressure equalization, to adjoin the chamber which is intended to be vented. A free end of the venting pipe projects from below into a recess which is provided by a component and which is closed upwardly and in which a gas bubble accumulates when a water level increases. The free end of the venting pipe projects into this gas bubble with a venting opening. This additional component consequently provides a type of diving bell for the venting opening in order to ensure that, with an increasing water level around the electric machine, the venting opening of the venting pipe is reliably arranged in the gas bubble in the recess, whereby an influx of water into the chamber via the venting opening of the venting pipe can be at least substantially prevented. The component is arranged above the chamber in a position fitted in the motor vehicle in order to reliably surround the venting pipe which upwardly adjoins the chamber, which is intended to be vented, in the recess for forming the diving bell. As a result of the arrangement of the free end of the venting pipe in the recess, the free end of the venting pipe is upwardly surrounded by the recess in the manner of a diving bell and consequently protected from incoming water. By gas flowing in or out through the venting opening into or out of the chamber, the pressure equalization can be carried out in the chamber. Consequently, the pressure equalization arrangement allows a safeguarding of a pressure equalization of the chamber via the venting opening, wherein by the venting pipe being arranged in the recess of the component at the same time, the chamber is particularly well protected from any penetration of water via the venting pipe. In this instance, the venting pipe constitutes a particularly simple and robust solution for the pressure equalization of the chamber.

In another embodiment of the invention, there is provision for the venting opening to be arranged above a predetermined wading line. This wading line defines a maximum water depth through which the motor vehicle can drive and consequently the water depth for which the motor vehicle is configured. By arranging the venting opening above the predetermined wading line, a pressure which acts on the gas bubble can be limited during an increase of the water level up to the predetermined wading line relative to the electric machine, whereby a sufficient pressure equalization can be ensured via the venting pipe for the chamber.

In another embodiment of the invention, there is provision for the chamber to be a brush chamber of the electric machine. Consequently, brush elements can be in electrical contact with a rotating element in the brush chamber, such as, for example, a shaft, in order to allow transmission of electrical energy via the brush elements. In this instance, for example, the brush chamber can be constructed in a dry manner in contrast to additional regions, which adjoin the chamber, of the electric machine which may be, for example, lubricated with oil or cooled with oil. If a reduced pressure occurs in the chamber, consequently, oil can be drawn as a result of the reduced pressure out of the regions adjacent to the chamber into the chamber and can consequently contaminate the chamber. The pressure equalization of the chamber can be carried out via the venting opening of the venting pipe, whereby the reduced pressure can be limited in the chamber or can in particular be prevented. Consequently, an introduction of oil or other contaminants into the chamber from regions, which are adjacent to the chamber, of the electric machine can be at least substantially prevented.

In another embodiment of the invention, there is provision for the brush chamber to be associated with a drive shaft of the electric machine. Via the brush elements of the brush chamber, electrical energy can be provided for driving the drive shaft of the electric machine. Consequently, it may be particularly advantageous for reliable driving of the drive shaft for the chamber which is the brush chamber of the electric machine to be free from contaminations, such as dust and oil, in order to allow safe and reliable driving of the drive shaft.

In another embodiment of the invention, there is provision for the component to be an insulation component. The insulation component may be in particular a so-called acoustic capsule. This insulation component is arranged in the fitted position at an upper side of the electric machine. Consequently, the insulation component is arranged at least in regions above the chamber which is intended to be vented and provides the recess which surrounds the venting pipe upwardly. The provision of the recess in the insulation component allows with a single component a particularly large number of different functions to be enabled, such as in this instance a noise insulation and/or thermal insulation of the electric machine and prevention of an influx of water via the venting pipe into the chamber. Consequently, it is possible to dispense with the provision of many different components for the respective functions in the electric machine.

In another embodiment of the invention, there is provision for the component to be made from a foam, wherein a wall, which delimits the recess, of the component is constructed in a gas-tight and water-tight manner. By making the component from foam, the component is particularly lightweight and can additionally have insulating properties. For example, the component can be produced from the foam in the context of an injection-molding method. The wall, which is configured in a gas-tight and water-tight manner and which delimits the recess, of the component ensures that an introduction of water via the component, particularly via the wall, which delimits the recess, of the component into the diving bell, which is formed by the recess around the free end of the venting pipe, can be prevented with particularly great reliability. The venting opening of the venting pipe is thereby protected particularly well from incoming water and at the same time from the gas bubble escaping.

In another embodiment of the invention, there is provision for the recess of the component to be provided by a hole of the component. By introducing the hole into the component, consequently, the recess can be provided particularly simply. The recess can thereby be provided with particularly little complexity and consequently the protection of the chamber from incoming water can be provided in a particularly reliable manner.

In another embodiment of the invention, there is provision for the venting pipe to be screwed or pressed on a bearing plate, which delimits the chamber, of the electric machine. In this case, the venting pipe can project outwardly over a cover, which delimits the chamber, and/or a bearing plate and is particularly securely retained thereon by the screwing or by the pressing. The venting pipe is thereby fixed particularly securely in the orientation thereof in the fitted position, whereby again the free end of the venting pipe can be arranged particularly simply in the recess of the component during assembly of the pressure equalization arrangement.

The invention further relates to an electric machine for a motor vehicle which is configured to drive the motor vehicle with electrical energy. This electric machine comprises a chamber having a venting pipe which adjoins the chamber which is intended to be vented and a component which provides an upwardly closed recess. As a result of the venting pipe, gas can flow out of the chamber for pressure equalization. Furthermore, gas can flow into the chamber via the venting pipe for the pressure equalization. A free end of the venting pipe projects from below into the recess, wherein a venting opening which is arranged at the free end of the venting pipe projects so far into the recess that the venting opening is arranged in a gas bubble which accumulates in the recess when a water level rises. The electric machine consequently has a pressure equalization arrangement, as already described in connection with the pressure equalization arrangement according to the invention. Advantages and advantageous further developments of the pressure equalization arrangement according to the invention are intended to be considered to be advantages and advantageous further developments of the electric machine, and vice versa.

In another embodiment of the invention, there is provision for the chamber to be a brush chamber of the electric machine and for the electric machine to be in the form of a wet-running electric motor. In this case, the brush chamber of the electric machine is dry during operation of the electric machine. Wet regions of the electric machine can directly adjoin the brush chamber. In order to prevent liquid, in particular oil, from being introduced from the wet regions of the electric machine into the dry brush chamber as a result of a pressure difference between the wet regions of the electric machine and the brush chamber, the venting pipe which allows the pressure equalization of the brush chamber is provided. Consequently, pressure differences between wet regions of the electric machine and the brush chamber can be limited, in particular prevented. By arranging the venting pipe in the recess of the component, an introduction of water via the venting opening of the venting pipe into the brush chamber can further be prevented. The brush chamber is thereby particularly well protected from contamination, whereby a particularly long service-life of the electric machine can be achieved.

Additional features of the invention can be derived from the claims, the Figures and the description of the Figures. The features and feature combinations which are mentioned above in the description and the features and feature combinations which are set out below in the description of the Figures and/or in the Figures only can be used not only in the combination set out, but also in other combinations or alone without departing from the scope of the invention.

### BRIEF DESCRIPTION OF THE DRAWINGS

FIG. 1 shows a schematic sectioned view of an electric machine having a housing, a bearing plate which adjoins the housing and a housing cover, wherein the housing cover surrounds a brush chamber as a chamber which is configured to be dry and which is sealed with respect to a wet-operated rotor/stator chamber via a radial shaft sealing ring;

FIG. 2 shows a schematic perspective view of the electric machine having a venting pipe which is retained on the bearing plate and which adjoins the chamber which is intended to be vented, in this case the brush chamber, wherein via the venting pipe a pressure equalization of the chamber can be carried out and a free end of the venting pipe projects into a recess, which is downwardly open and upwardly closed, of an insulation component of the electric machine, whereby a venting opening which is arranged at the free end of the venting pipe is protected from incoming water according to a principle of a diving bell;

FIGS. 3a and 3b show a schematic perspective view and a schematic sectional view of the venting pipe which is arranged on the bearing plate and which projects from below into the recess of the insulation component; and

FIG. 4 shows an additional schematic sectional view of the venting pipe which is retained on the bearing plate and which projects from below into the recess of the component and via which a pressure equalization of the chamber can be carried out.

### DETAILED DESCRIPTION OF THE DRAWINGS

In the Figures, identical and functionally identical elements are referred to with the same reference numerals.

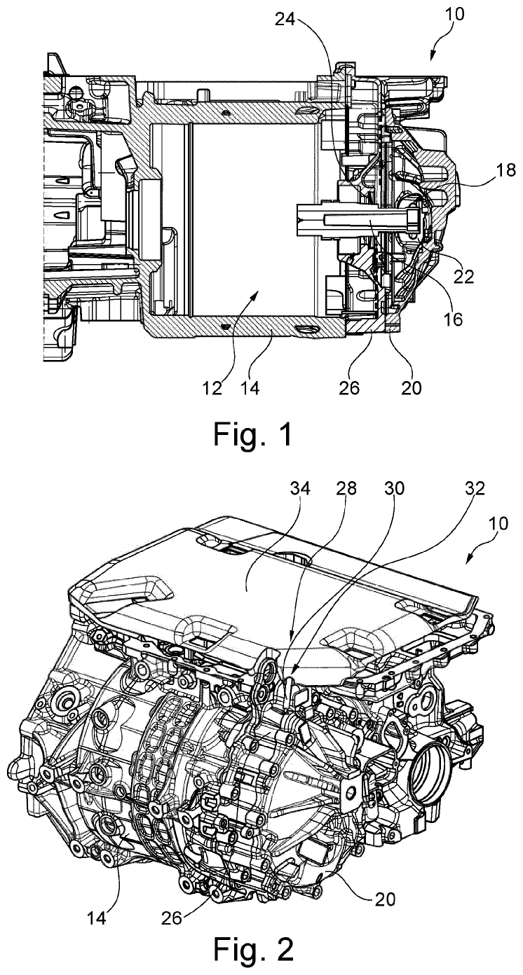

FIG. 1 illustrates a schematic sectioned view of an electric machine 10. The electric machine 10 comprises a rotor which is not shown in FIG. 1 and a stator, which are intended to be arranged in a wet-operated rotor/stator chamber 12. This rotor/stator chamber 12 is delimited by a housing 14 of the electric machine 10. The electric machine 10 further has a drive shaft 16 which opens with one end thereof into a brush chamber 18 of the electric machine 10. The drive shaft 16 can be electrically contacted via brush elements in this brush chamber 18. The brush chamber 18 is formed by a chamber 22 which is delimited by a housing cover 20 of the electric machine 10. This brush chamber 18 is operated in the dry state. An introduction of oil or other liquids from the rotor/stator chamber 12 into the brush chamber 18 has to be prevented in order to avoid damage to the brush elements.

In order to seal the brush chamber 18 with respect to the rotor/stator chamber 12, in this instance a radial shaft sealing ring 24 which surrounds the drive shaft 16 is provided. This radial shaft sealing ring 24 is arranged in this instance in a B bearing plate 26. This B bearing plate 26 is arranged between the housing 14 and the housing cover 20. The housing cover 20 is consequently supported via the B bearing plate 26 against the housing 14. In order to be able to prevent introduction of the oil or liquid from the rotor/stator chamber 12 into the brush chamber 18 as a result of a reduced pressure which occurs in the brush chamber 18, a pressure equalization arrangement 28 which allows a pressure equalization of the chamber 22 with an environment of the electric machine 10 is provided.

The pressure equalization arrangement 28 can be seen in FIG. 2, in which the electric machine 10 is illustrated as a perspective view. In this case, it can be seen that a venting pipe 30 projects out of the B bearing plate 26. The venting pipe 30 is made from aluminum in this case. This venting pipe 30 projects upward in the installation direction upward from the B bearing plate 26. The venting pipe 30 adjoins the chamber 22 which is intended to be vented and is connected thereto in fluid terms. As can be seen in FIG. 2, a free end 32 of the venting pipe 30 projects into an insulation component 34, which is a so-called acoustic capsule in this case.

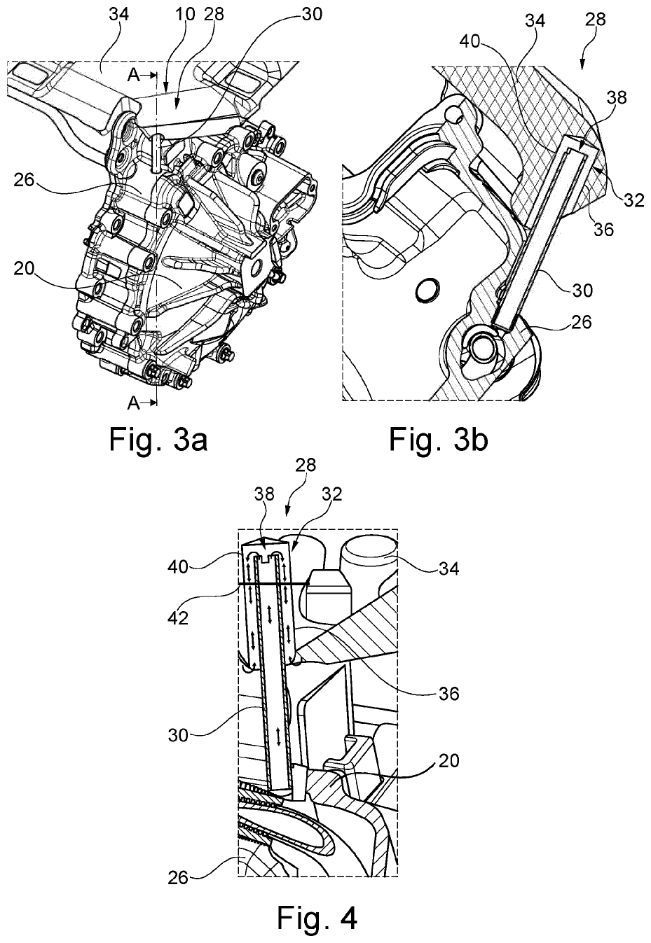

This insulation component 34 insulates the housing 14 of the electric machine 10 upwardly with respect to noises and/or heat. The insulation component 34 is made from a polyurethane foam in this case. In FIG. 3a, the pressure equalization arrangement 28 is illustrated to an enlarged scale. In FIG. 3b, the pressure equalization arrangement 28 is shown as a schematic sectional view. In this case, it is possible to see that the venting pipe 30 which is fluidically connected to the chamber 22 which is intended to be vented projects with the free end 32 thereof into a recess 36 of the insulation component 34. This recess 36 surrounds the free end 32 of the venting pipe 30 in an upward direction. The venting pipe 30 is consequently introduced from below into the recess 36 of the insulation component 34. In the case of a water level which is rising around the electric machine 10, a gas bubble accumulates in the recess 36 on the basis of the diving bell principle. The free end 32 of the venting pipe 30 is arranged in such a manner that the free end 32 is arranged in the gas bubble which accumulates in the recess 36 in the case of the rising water level. Consequently, the pressure equalization of the chamber 22 continues to be possible via the free end 32 of the venting pipe 30 even with an increasing water level around the electric machine 10 as a result of the arrangement of the free end 32 in the gas bubble which accumulates in the recess 36. A venting opening 38 of the venting pipe 30 which is arranged at the free end 32 is arranged in a region of the recess 36, in which the gas bubble accumulates in the event of the rising water level. In order to prevent introduction of water via a wall 40, which delimits the recess 36, of the insulation component 34 and an escape of the gas bubble which accumulates in the recess 36, there is provision for the wall 40 which delimits the recess 36 to be constructed in a gas-tight and water-tight manner. The recess 36 can already be provided during production of the insulation component 34, for example, in the context of an injection-molding method, or can be introduced in the insulation component 34 after the insulation component 34 has been provided, in particular in the form of a hole. When the insulation component 34 is provided in the injection-molding, the insulation component 34 can be injection-molded as a foam component.

In order to ensure particularly secure retention of the venting pipe 30 on the B bearing plate 26 and consequently a precise orientation of the venting pipe 30 relative to the insulation component 34, the venting pipe 30 can be screwed and/or pressed and/or adhesively bonded to the B bearing plate 26.

FIG. 4 shows another schematic sectional view of the pressure equalization arrangement 28. In this case, it can be seen that the venting opening 38 is arranged in this case above a predetermined wading line 42 of the electric machine 10.

The described pressure equalization arrangement 28 is based on the recognition that motor systems, in particular both combustion engines and electric motors, have to meet requirements resulting from a vehicle design and consequently superordinate system properties. In this case, a defined wading depth of the motor vehicle has to be enabled, that is to say that driving through water up to a specific depth has to be enabled without the system becoming damaged. In this case, this is a customer requirement, that means that in practice it originates from customers. Furthermore, an IP-7 sealing test must be complied with, which may be an authorization condition in some countries. If a venting of a chamber, in this case the chamber 22, which may become heated during operation of the electric machine 10, whereby air which is located in the chamber 22 expands, is intended to be carried out, the above-mentioned conditions, such as the IP-7 sealing test and the enabling of the defined wading depth, have to be complied with in all situations. In order to meet this wading requirement, the venting opening 38 of the chamber, and consequently a permanent opening of the chamber 22 in an outward direction, can be placed above a specific height which is predetermined by the wading depth so that water cannot reach the venting opening 38 when driving through water. In the IP-7 sealing test, the entire electric machine 10 has to be immersed so that, in order to meet this prerequisite, a displacement of the venting opening 38 to a higher position does not appear to be advantageous. Instead, in the prior art in order to achieve this IP requirement floating valves which close at a predetermined water level or a combination of one-way valve and membranes are used. If these valves are used, they have to be protected against dust both from the exterior and from the chamber 22 which is intended to be vented, or have to be configured to be robust enough. Valves or membranes are usually integrated in adapters which can be plugged in and which require additional space in the construction area. Adapters which are configured accordingly often have special geometries as a result of problems with the structural space and are consequently not standard parts, which increases costs for these components disproportionately.

In the pressure equalization arrangement 28, the acoustic capsule and consequently the insulation component 34 are used and have at the lower side thereof the recess 36, which is a pocket. With this recess 36, the insulation component 34 provides a cap or a diving bell for the free end 32, which is inserted from below into the recess 36, of the venting pipe 30, wherein the free end 32 is received in the recess 36. A diving bell can thereby be produced around the venting opening 38 which is arranged at the free end 32 and results in at least substantially no water being introduced into the chamber 22 during immersion of the electric machine 10 in the context of an IP-7 sealing test. With this proposed solution, without using additional components and with the available structural space a venting action of the chamber 22 as is suitable for IP-7 can be constituted. This described pressure equalization arrangement 28 is particularly robust, in particular in comparison with solutions with valve/membrane concepts.

The venting of the brush chamber 18 of a traction unit, in this instance the electric machine 10, is carried out via the venting pipe 30 which is fitted in an upright manner. The venting opening 38 is arranged at or above the predetermined wading line 42 in the fitted position. The pocket, in this instance the recess 36, in which the free end 32 of the venting pipe 30 is received is arranged in the acoustic capsule. If the electric machine 10 is placed under water, according to the diving bell principle water is then prevented from being introduced via the venting opening 38 into the venting pipe 30. The venting pipe 30 is directed from an upper side of the chamber 22 upward. The free end 32 of the venting pipe 30 is introduced from below into an original structural space of the acoustic capsule. In this region, however, the acoustic capsule is provided with the mentioned recess 36 in order to enable the immersion of the free end 32 of the venting pipe 30 into the recess 36. The acoustic capsule is particularly used as noise insulation and for keeping the housing 14 of the electric machine warm. A particularly good degree of efficiency as a result of the insulation of the electric machine 10 can thereby be achieved and a thermal balance of the electric machine 10 can be produced particularly well.

The damp rotor shaft is sealed with respect to the brush chamber 18 by the radial shaft sealing ring 24. In particular, carbon pieces, which during operation of the electric machine 10 can produce abrasion, are arranged as brush elements in the brush chamber 18. If these rubbed-off parts come into contact with oil, a short-circuit of the electric machine 10 can then occur. Introduction of oil from the rotor/stator chamber 12 into the brush chamber 18 can be prevented particularly reliably by means of the pressure equalization arrangement 28.

Overall, the invention sets out how an acoustic capsule, in this instance the insulation component 34, can provide the integrated housing, in this instance the recess 36, for a pressure equalization element, in this case the venting pipe 30.

### LIST OF REFERENCE NUMERALS

10 Electric machine
12 Rotor/stator chamber
14 Housing
16 Drive shaft
18 Brush chamber
20 Housing cover
22 Chamber
24 Radial shaft sealing ring
26 B bearing plate
28 Pressure equalization arrangement
30 Venting pipe
32 Free end
34 Insulation component
36 Recess
38 Venting opening
40 Wall
42 Wading line

1.-10. (canceled)

11. A pressure equalization arrangement for a chamber of an electric machine of a motor vehicle, the pressure equalization arrangement comprising:
a venting pipe, via which gas can flow out of the chamber for pressure equalization, that adjoins the chamber which is vented,
wherein a free end of the venting pipe projects from below into a recess which is provided by a component and which is closed upwardly and in which a gas bubble in which the free end of the venting pipe projects with a venting opening accumulates when a water level increases.

12. The pressure equalization arrangement according to claim 11, wherein the venting opening is arranged above a predetermined wading line.

13. The pressure equalization arrangement according to claim 11, wherein the chamber is a brush chamber of the electric machine.

14. The pressure equalization arrangement according to claim 12, wherein the chamber is a brush chamber of the electric machine.

15. The pressure equalization arrangement according to claim 13, wherein the brush chamber is associated with a drive shaft of the electric machine.

16. The pressure equalization arrangement according to claim 14, wherein the brush chamber is associated with a drive shaft of the electric machine.

17. The pressure equalization arrangement according to claim 11, wherein the component is an insulation component.

18. The pressure equalization arrangement according to claim 12, wherein the component is an insulation component.

19. The pressure equalization arrangement according to claim 13, wherein the component is an insulation component.

20. The pressure equalization arrangement according to claim 11, wherein the component is made from a foam, wherein a wall, which delimits the recess, of the component is constructed in a gas-tight and water-tight manner.

21. The pressure equalization arrangement according to claim 12, wherein the component is made from a foam, wherein a wall, which delimits the recess, of the component is constructed in a gas-tight and water-tight manner.

22. The pressure equalization arrangement according to claim 13, wherein the component is made from a foam, wherein a wall, which delimits the recess, of the component is constructed in a gas-tight and water-tight manner.

23. The pressure equalization arrangement according to claim 11, wherein the recess of the component is provided by a hole of the component.

24. The pressure equalization arrangement according to claim 12, wherein the recess of the component is provided by a hole of the component.

25. The pressure equalization arrangement according to claim 13, wherein the recess of the component is provided by a hole of the component.

26. The pressure equalization arrangement according to claim 11, wherein the venting pipe is screwed or pressed on a bearing plate, which delimits the chamber, of the electric machine.

27. The pressure equalization arrangement according to claim 12, wherein the venting pipe is screwed or pressed on a bearing plate, which delimits the chamber, of the electric machine.

28. The pressure equalization arrangement according to claim 13, wherein the venting pipe is screwed or pressed on a bearing plate, which delimits the chamber, of the electric machine.

29. An electric machine for a motor vehicle comprising:
a chamber;
a venting pipe which adjoins the chamber which is intended to be vented and via which gas can flow out of the chamber for pressure equalization; and
a component which provides an upwardly closed recess;
wherein a free end of the venting pipe projects from below into the recess, in which a gas bubble in which the free end of the venting pipe projects with a venting opening accumulates when a water level rises.

30. The electric machine according to claim 29, wherein the chamber is a brush chamber of the electric machine and the electric machine is in the form of a wet-running electric motor.
